(19) United States
(12) Patent Application Publication
(10) Pub. No.: US 2013/0151549 A1
(43) Pub. Date: Jun. 13, 2013

(54) Method and Apparatus for Updating a Database of Online Content

(71) Applicants: Konstantinos Papamiltiadis, London (GB); Simon Rodgers, Ely (GB); Christopher Porter, Suffolk (GB)

(72) Inventors: Konstantinos Papamiltiadis, London (GB); Simon Rodgers, Ely (GB); Christopher Porter, Suffolk (GB)

(73) Assignee: TAPTU LTD, Cambridge (GB)

(21) Appl. No.: 13/313,313

(22) Filed: Dec. 7, 2011

(51) Int. Cl. G06F 17/30

(52) U.S. Cl. 707/769; 707/803; 707/E17.005; 707/E17.014

(57) ABSTRACT

A system comprising a database of streams of online content and a processor for updating said database, the processor being arranged to
receive a first user stream comprising a set of elements of online content together with an associated tag;
determine whether or not said first user stream is to be added to the database by considering whether said associated tag meets predefined criteria; and
update said database if said predefined criteria are met;
wherein said updating step includes storing said first user stream in said database together with said associated tag and information identifying said first user.

### FIELD OF THE INVENTION

This invention relates to methods and apparatus for updating a database associated with a set of elements of online content.

### BACKGROUND ART

Search engines are known for retrieving a list of addresses of documents on the Web relevant to a search keyword or keywords. A search engine is typically a remotely accessible software program which indexes Internet addresses (universal resource locators (“URLs”), usenet, file transfer protocols (“FTPs”), image locations, etc). The index comprises a list of the keywords in the documents. As any one keyword in the index may be present in hundreds of documents, the index will have for each keyword a list of pointers to these documents, and some way of ranking them by relevance.

There are huge numbers of websites on the world wide web, many of which that publish feeds of updating content via RSS (or similar). Accordingly, each of these websites are themselves generating a plurality of articles or stories.

The concept of a user creating a tag for such RSS feeds is known. For example, if an RSS feed is tagged “Topic X”, each article published under the RSS is tagged as “Topic X”.

The present applicant has recognised that there is a need for an improved method of updating the keywords associated with each document.

### SUMMARY OF THE INVENTION

According to a first aspect of the invention, there is provided a system comprising a database and a processor for updating said database, the processor being configured to:
receive a first user stream comprising a set of elements of online content together with an associated tag;
determine whether or not said associated tag is to be added to the database by considering whether said associated tag meets predefined criteria; and
update said database if said predefined criteria are met;
wherein said updating step includes storing said associated tag in said database.

Each associated tag may be termed a label. The elements may be sources such as websites or may be individual stories or articles from such sources or may be a combination of sources and stories.

The present applicant has recognised that the tag itself may be useful to the system whether used in conjunction with or separately from the elements associated with the stream. For example, the tag may:
a) Provide contextual information about a story and thus can be used as a signal for contextual advertisement
b) Be used to find clusters of stories that are related to this one or children of this Tag and mark those related stories with the same Tag.

The updating step may also comprise adding said associated tag to each element within the stream. Both tag and associated elements may be stored in the database (which may also be termed a stream store). Alternatively, the tag may be stored in the database with pointers to all associated elements. In this way, the system provides the capability to the end users to specifically tag articles and not just elements related to the stream.

Said predefined criteria may include one or more of a level of uniqueness of said tag, the nature of the elements contained in said first user stream and the country of origin for said first user stream.

The stream and its associated tag may be created in a variety of different ways, e.g:
a) as a mixed stream
b) as a search stream
c) by curating a stream.

A search stream may be created by a user searching within another stream, e.g. a mixed stream, using a particular keyword, so as to return a plurality of search results. Accordingly, in this case, the associated tag is the search keyword. In general, said search results may be individual stories and each story is tagged with the search keyword.

A mixed stream may be created by a user. For example, said system may further comprise a user interface to allow said first user to define which elements are to be included in said first user stream and to define the associated tag. A mixed stream may comprise a plurality of elements in the form of sources. In this case, the source and each individual story within the source may be associated with the tag.

The system may be further arranged to allow the user to define the set of sources associated with a tag by specifying one of more of the following:
1. sources selected from a comprehensive set of sources (i.e. BBC News, CNN World, etc)
2. a subset of the comprehensive sources recommended by the system which may be termed as Tags and may be related to certain Topics/Genres (Politics, World Affairs, Business, Technology, etc)
3. sources which a user has previously grouped together under a certain user supplied Tag (i.e. John's Politics, or Fred's Legal Stream, etc), these may be terms Mixed
4. All the above
5. None specified

Said database may be further configured to store curated streams of online content and wherein said updating step includes storing said elements from said first user stream in said database together with said associated tag and preferably information identifying said first user. For such a curated stream, the elements may be in the form of individual stories which are taken from various elements. In this case, the stories but not the sources from which they are taken are associated with the tag.

Said processor may be configured to update said database by
detecting that said first user is accessing at least one additional element which is not included in said first user stream stored within said database;
displaying a user interface to said first user, said user interface comprising a user input to add said at least one additional source to said first user stream;
determining whether or not said user adds said at least one additional source to said first user stream; and
updating said database based on said determining step.

In this way, said first user that reads and/or shares a story via mail or any of the social networks may tag the story after the name of a stream. Once the story is tagged it becomes part of the curated stream.

Said system may further comprise a display for displaying said first user stream to another user wherein said display is updated when said database is updated. In this way, subscribers of the curated streams will see a story added to the stream by a user as it comes in.

The system may provide for multiple users to curate a single stream. In other words, said processor may be further configured to update said database by
determining that a second user is associated with said first user stream;
detecting that at least one of said first user and said second user is accessing at least one additional element which is not included in said first user stream stored within said database;
displaying a user interface to said at least one user accessing said at least one additional element, said user interface comprising a user input to add said at least one additional element to said first user stream;
determining whether or not said at least one user adds said at least one additional element to said first user stream; and
updating said database based on said determining step.

One or both of the above aspects of the invention may also provide granularity of searching and/or a more personalised search to a user.

According to another aspect of the invention, there is provided apparatus for providing a search service for finding online content, the apparatus being arranged to
receive a search query from a user;
access a database comprising a plurality of elements of online content, each element having an associated tag;
identify a tag which is contextually relevant to the search query;
select at least one element associated with said identified tag to include in a set of search results to said user, and
send search results to said user.

The search results sent to the user may be a visual feed, also known as stream, comprising stories or other material. The results may be arranged in chronological order. The at least one element may be displayed with said tag where appropriate. Once the user has received the search results, the user can scroll through to the other elements associated with the same tag and consume content coming from these elements.

The invention further provides processor control code to implement the above-described systems and methods, for example on a general purpose computer system or on a digital signal processor (DSP). The code is provided on a physical data carrier such as a disk, CD- or DVD-ROM, programmed memory such as non-volatile memory (eg Flash) or read-only memory (Firmware). Code (and/or data) to implement embodiments of the invention may comprise source, object or executable code in a conventional programming language (interpreted or compiled) such as C, or assembly code. As the skilled person will appreciate such code and/or data may be distributed between a plurality of coupled components in communication with one another.

### BRIEF DESCRIPTION OF THE DRAWINGS

The invention is diagrammatically illustrated, by way of example, in the accompanying drawings, in which:

FIG. 1a is a schematic block diagram of the components of a first arrangement of the system;

FIG. 1b is a flowchart of the steps for a method of updating a database of FIG. 1a;

FIGS. 2a to 2d each show schematic representations of a user interface and together combine to show a flowchart of the steps of one method of creating a tag;

FIGS. 3a to 3d each show schematic representations of a user interface and together combine to show a flowchart of the steps of another method of creating a tag;

FIG. 4a is a schematic block diagram of the components of a second arrangement of the system;

FIG. 4b is a variation of the arrangement of FIG. 4a;

FIG. 5a is a flowchart of the steps of a method of creating and updating a user curated stream carried out by the system of FIG. 2a;

FIG. 5b is a flowchart of the steps of an alternative method of creating and updating a user curated stream;

FIGS. 6a to 6d are screen shots of graphical user interfaces displayed to users at various points during the method of FIG. 5a;

FIGS. 7a to 7d are screen shots of graphical user interfaces displayed to users showing tags; and

FIG. 8 is a flowchart of a method of improving searching using a user curated stream generated by the method of FIG. 4a.

### DETAILED DESCRIPTION OF THE DRAWINGS

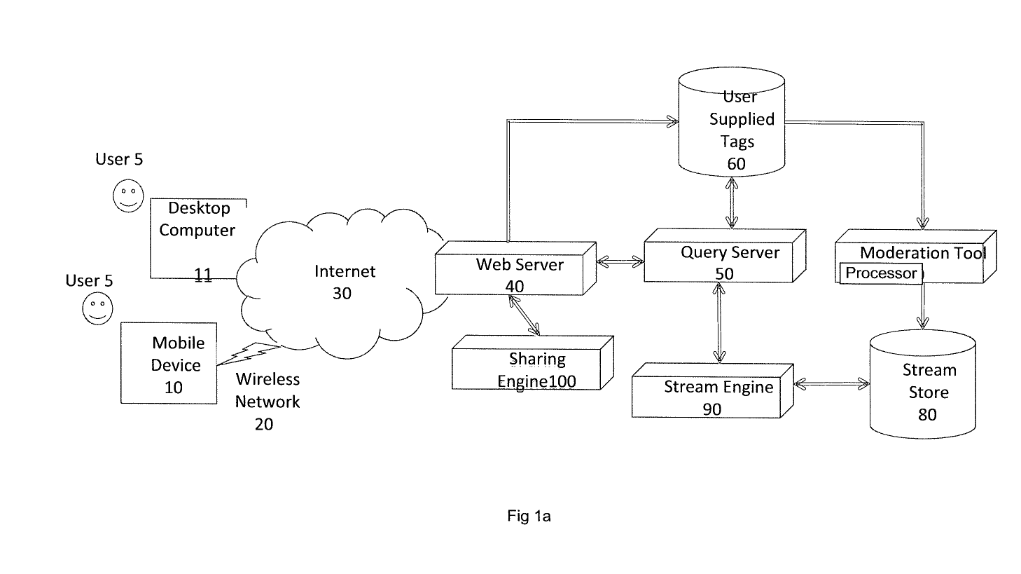

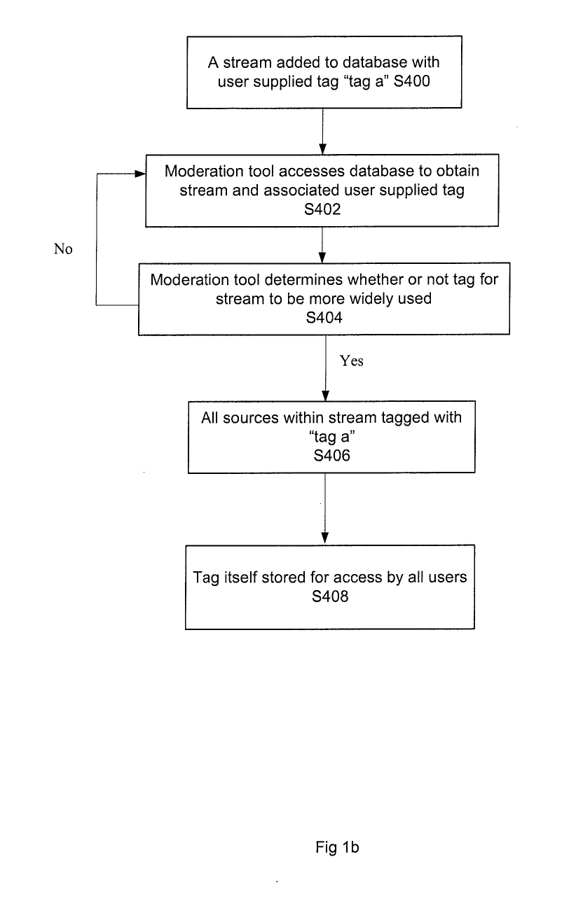

The overall topology of one arrangement of the system is illustrated in FIG. 1a. This system can be formed of many servers and databases distributed across a network, or in principle they can be consolidated at a single location or machine.

As shown in FIG. 1a, a plurality of users 5 are connected to the Internet 30 via desktop computers 11 or mobile devices 10, 12. The users (mobile users) on mobile devices are connected to a wireless network 20 managed by a network operator, which is in turn connected to the Internet via a WAP gateway, IP router or other similar device (not shown explicitly).

The users communicate via the Internet with a web server 40 which is connected to various components to provide different functionality. The web server 40 is connected a query server 50 to which a user sends a search request. The search results sent to the users by the query server 50 can be tailored to preferences of the user or to characteristics of their device.

A stream engine 90 and connected stream store 80 form part of the system. In the Figure they are shown as connected to the query server 50 but they may be connected to other components within the system. In this context, a stream is a visual feed or source which provides a plurality of articles or stories. The stream may comprise a single source or website which alone provides a plurality of stories, e.g. a news site such as “http://www.bbc.co.uk”. Alternatively, the stream may comprise a plurality of sources or websites which together provide a plurality of stories. Alternatively, the stream may comprise a plurality of individual stories but not the overall sources of these stories. Finally, the stream may be a mix of sources and/or stories.

The stream store 80 stores a plurality of different databases of streams. There are databases which comprise a plurality of user curated streams each having a set of sources that are grouped under a user defined tag. There may also be databases comprising streams defined by the system provider. These databases may be grouped by topic, e.g. politics, world affairs, business or technology.

The web server 40 is connected to a database of user supplied tags 60 which stores tags which are created by said users in a variety of different ways as described in more detail below. This database is connected to a moderation tool 70 comprising a processor which can access the stored tags and determine whether or not to transfer the tags into the stream store. The moderation tool may be a server or implemented in other hardware as described in more detail below. As set out above, the stream store 80 is connected to the query server 50 via a stream engine 90. This allows access to the stream store by all users.

An optional component of both arrangements is a sharing engine 100 which allows a user to share or publish information, e.g. stories. The sharing engine may have one or more databases to store registered users and streams of published search results. The publication (or sharing) of results could be achieved for example as set out in WO2009/001140 to the present applicant. The publication may be private, e.g. by adding the results so that they are only visible to that user or as the limited publication to nominated users only (i.e. friends). Alternatively, publication may be public publication so that results can be viewed by any user whether identified (logged in) or not. For the group privacy implementation, the concept of user friends is added. Friends are declared by a user thus enabling those declared friends access to view items published as private.

Sharing may be achieved by the following steps:
User clicks on the sharing button of the Search Stream
User selects whether to share the stream via:
   Facebook
   Twitter
   Linkedin
   Email
Appropriate dialogue window opens
   A tpt.to URL is generated for the Search Stream and posted as per the options selected above

FIG. 1b illustrates the steps in the method for updating the stream store database 80. At the first step S400, a stream is stored in the user supplied tag database 60 with its tag. Optionally, the addition of each new stream to the database may be published to the moderation tool. At step S402, the stream with its associated tag “tag a” is obtained by the moderation tool from the database. The moderation tool determines whether or not to include the tag “tag a” in the stream store is to be more widely used at step S404. The moderation tool may determine whether or not to include the tagged stream by considering some or all of the following illustrative criteria:
a) The level of uniqueness of the new tag. If the level is above a threshold value, the new tagged stream may be included. If the level is below a threshold value, the new tagged stream may still be included if it meets the other criteria.
b) The country of origin for the new tagged stream. There may be several streams with the same tag if the country of origin is different for each stream. This reflects the differences in language and locale for the different countries and thus means that different sources are more appropriate for the same tag in different countries. For example, Android Blogs in Germany are different from the Android Blogs in the US.
c) The nature of the elements within the new tagged stream. If the elements are similar to the name of the tag, e.g. a user has tagged BBC news as “My News”, this is not a very useful tag, particularly if a stream tagged “News” has already been created which includes BBC news.
d) The level of redundancy of the words within the tag, e.g. unnecessary words such as (the, my, old, etc) are disregarded.

If a tag is accepted, at step S406 all sources and/or stories within the stream are tagged with the accepted tag depending on the nature of the stream. This means that they can be displayed to any user with this tag as described above. The tags are also stored in the stream store database (Step S408), for access by all users.

The tags that are rejected still live within the user application and are private to the user that has curated the specific stream.

The reason for storing the accepted tags is that they provide context with regards to the source and the documents appearing under the source. For example, if the user mixes two blogs about Asian Food and renames or tags the mixed stream as “Asian Food Recipes”, the system automatically knows that each post on those blogs is related to Asia Food and Recipes.

The stream and its associated tag may be created in a variety of different ways, e.g:
a) by creating a mixed stream
b) by creating a search stream
c) by curating a stream.

The nature of the stream will determine how the tag is to be used, if it is accepted by the system.

For a mixed stream, the tag is assigned to each of the sources that makes up the stream. All of the stories or other content within each source inherit the tag. For example, if the source “BBC news” is tagged as “news”, all articles published by this website “BBC news” are tagged as “news”.

For a search stream, the tag is assigned to the content and not the overall source of the content. For example, a user searches for Lady Gaga in the stream tagged “Music” which contains stories from sources such as NME, MTV ect. , The search stream which is returned is a collection of stories relating to Lady Gaga. All this content, i.e. all the stories, displayed in the search result are tagged Lady Gaga. They also continue to be tagged “Music” from the original stream.

For a curated stream, like a search stream, the tag is assigned to the content and not the overall source of the content. This is because a user curated stream comprises a plurality of stories from various sources all having a tag created by the user. The tag is assigned to each story and not to the overall source of the story. However, if the curated stream also comprises a whole source as part of the curated stream, all content from this stream will have the tag like a mixed stream.

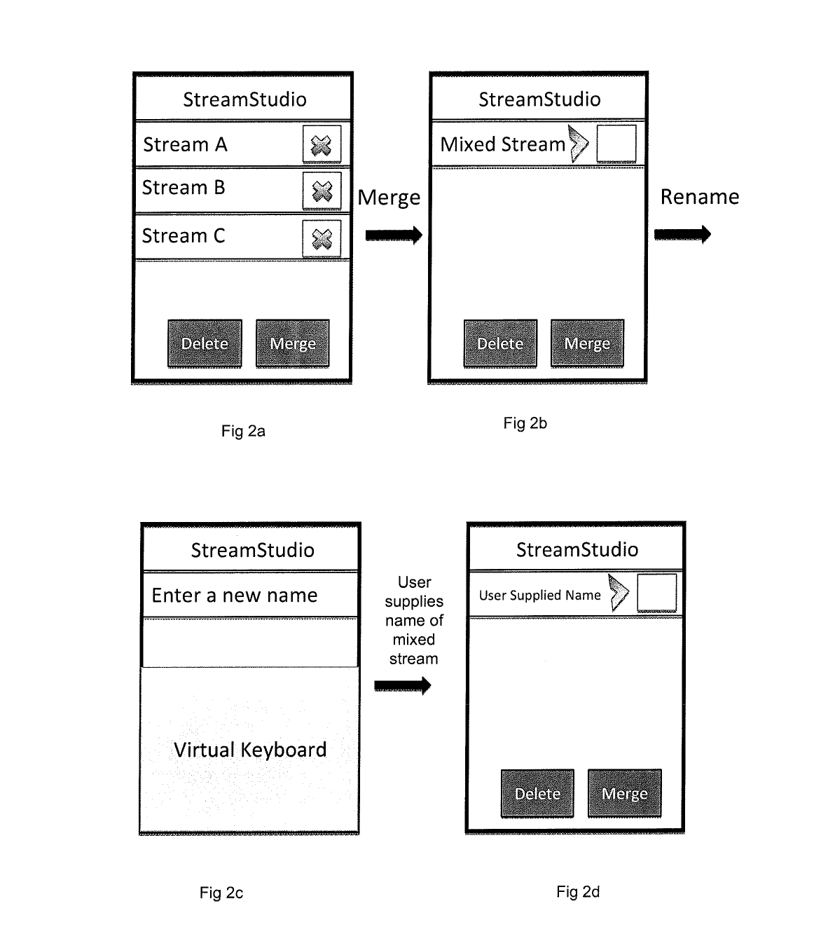

Referring to the screenshots in FIGS. 2a to 2d, the creation of a tag in the context of creation of a “mixed stream” is described. The mixed stream is a stream which contains a plurality of sources. A mixed stream may comprise a plurality of sources, e.g. websites. For example the mixed stream may be a personalised stream created as described in U.S. 61/525,936 filed Aug. 22, 2011, the contents of which are herein incorporated by reference. Alternatively, the mixed stream may be a user curated stream as described in more detail below. In this instance, the mixed stream comprises a plurality of sources and/or individual stories from such sources.

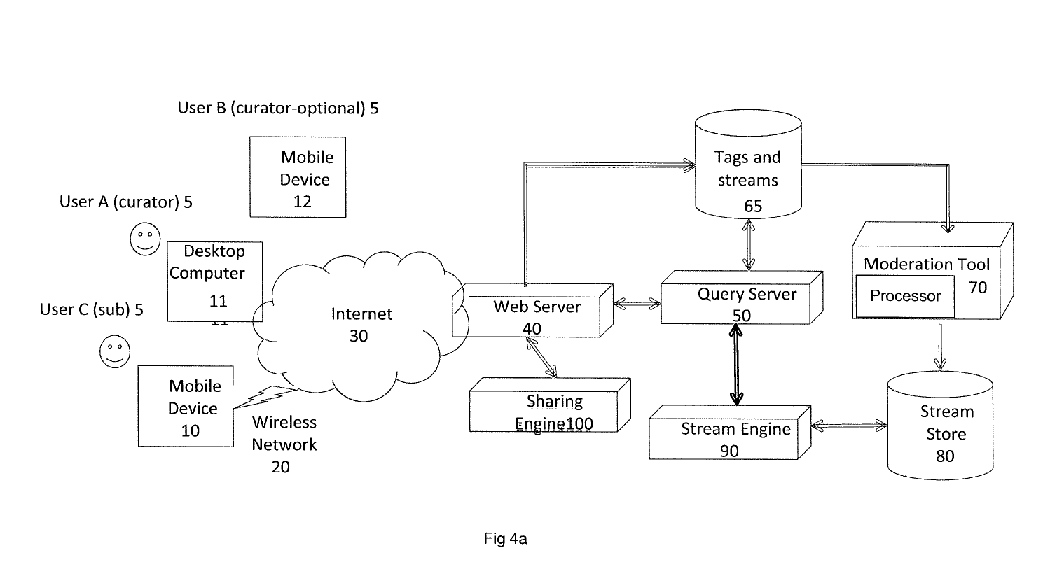

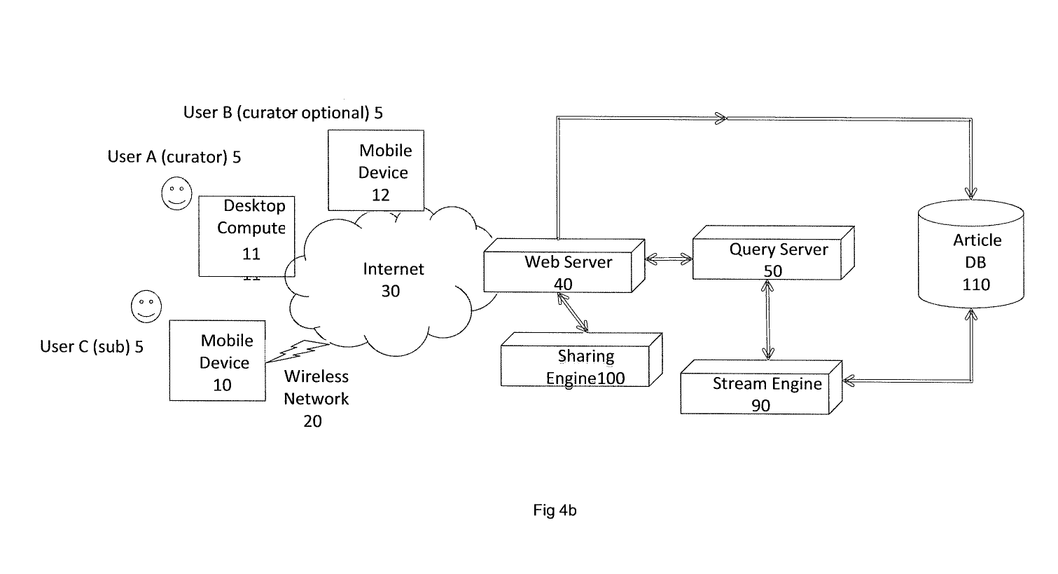

As shown in FIG. 2a, a user interface is displayed to the user which displays a plurality of sources. The user interface is configured to enable a user to delete sources from the stream, e.g. by clicking on the “X” to the side of the listed stream, or by clicking on “delete” at the bottom of the screen. The user interface may also comprise an input to add sources, perhaps in a different section of the user interface, for example by scrolling up and down the displayed list or by typing the title of the stream into a window on the user interface. As shown in FIG. 2a, each source is itself a stream but the sources may be websites or individual stories. These stories may be selected from the database of articles shown in FIG. 4b, more generally from the widely available resources of the Internet or from another source.

Once the user is happy with the selection of sources, the user interface includes an input for the user to verify the selection, for example “merge” as shown in the present example. The user interface updates to that shown in FIG. 2b indicating that the user is about to create a mixed stream. Once again the user interface includes an input for the user to verify that they wish to proceed, for example “merge” as shown in the present example. The user is taken to a user interface which includes an input to add a “tag” or name for the stream. FIG. 2c shows a keyboard on the user interface to allow a user to input the name of the tag, in this example replacing “mixed stream” with “user supplied tag” as shown in FIG. 2d. The user interface includes an input for the user to verify the selection, for example “merge” as shown in the present example.

If the user verifies the selection “user supplied tag” is transferred to the user supplied tag database to await moderation.

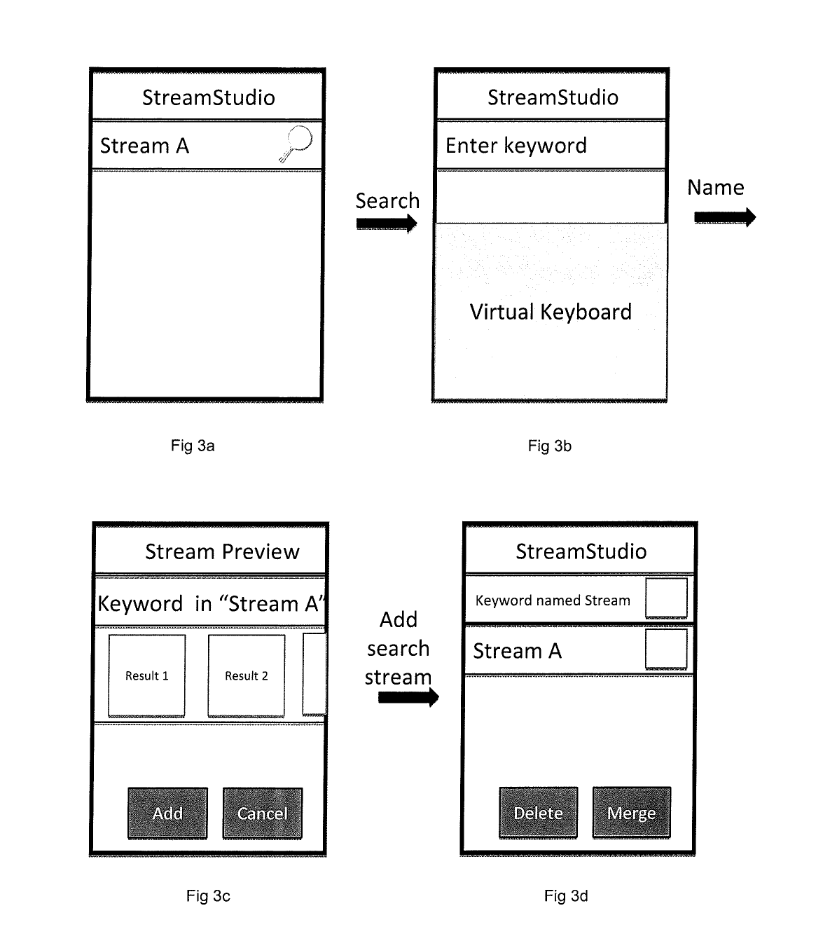

Referring to the screenshots in FIGS. 3a to 3d, the creation of a tag in the context of creation of a “search stream” is described. FIG. 3a shows that the user has selected stream A from the stream store database. The user wishes to search within the sources in this stream and thus the user interface in FIG. 3b is displayed. FIG. 3b shows a keyboard on the user interface to allow a user to input the search term or keyword. FIG. 3c displays all the sources in Stream A which return a positive result for the keyword, e.g. result 1, result 2. The user interface includes an input to allow a user to create a new stream associated with the keyword from the search, e.g. by clicking on “add” at the bottom of the interface. If the user selects “add”, all the sources from Stream A which returned a positive result for the keyword are tagged with the keyword. All such sources have two tags, namely “keyword” and “stream A”. Moreover, as shown in FIG. 3d, there are now two separate streams, the original “stream A” and one entitled “keyword”. The “keyword” is the tag transferred to the user supplied tag database to await moderation.

The overall topology of the system for the creation of a user curated stream is illustrated in FIGS. 4a and 4b. This system can be formed of many servers and databases distributed across a network, or in principle they can be consolidated at a single location or machine. Many of the components of the system are the same as those in FIG. 1a and thus the same numbering has been used where appropriate.

As shown in both FIGS. 4a and 4b, a plurality of users 5, e.g. user A, user B and user C are connected to the Internet 30 via desktop computers 11 or mobile devices 10,12. The users (mobile users) on mobile devices are connected to a wireless network 20 managed by a network operator, which is in turn connected to the Internet via a WAP gateway, IP router or other similar device (not shown explicitly).

The users communicate via the Internet with a web server 40 which is connected to various components to provide different functionality. The web server 40 is connected a query server 50 to which a user sends a search request. The search results sent to the users by the query server 50 can be tailored to preferences of the user or to characteristics of their device.

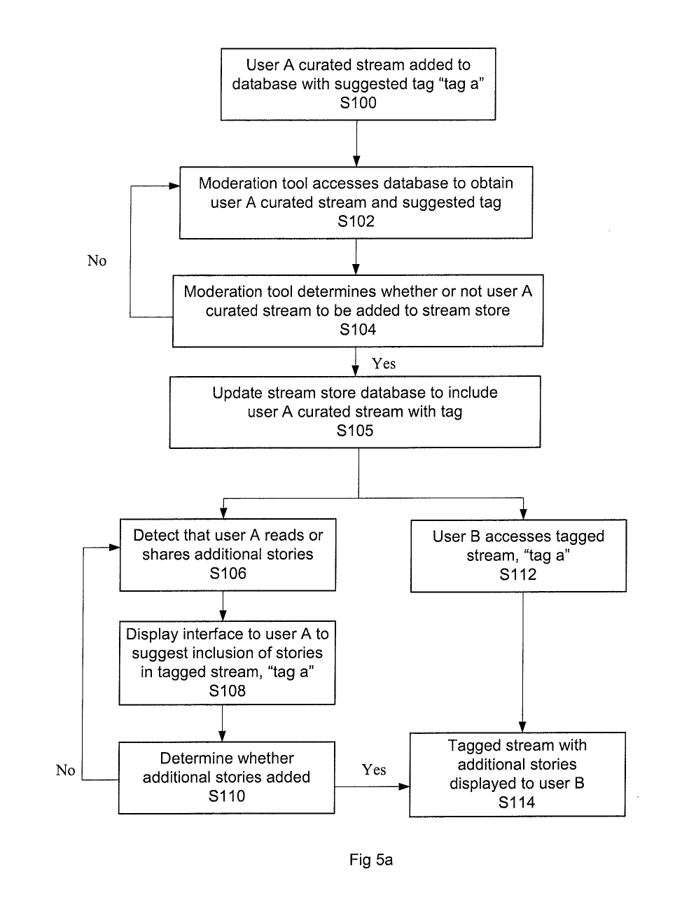

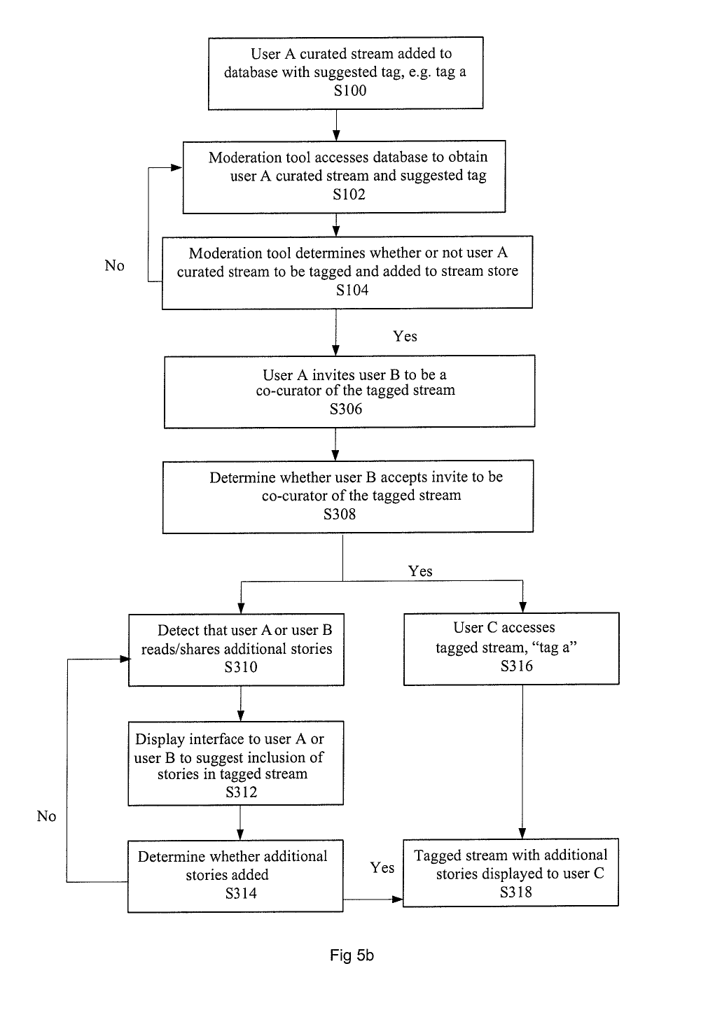

In FIG. 4a, a stream engine 90 and connected stream store 80 form part of the system. They are shown as connected to the query server 50 but they may be connected to other components within the system. In FIG. 4a, the web server 40 is connected to a database of user curated streams 65 which stores user curated streams as they are created. This database is connected to a moderation tool 70 which can access the stored user curated streams and determine whether or not to transfer them into the stream store as described in more detail in FIG. 5a. The moderation tool may be a server or implemented in other hardware as described in more detail below.

In an alternative arrangement shown in FIG. 4b, the query server 50 is connected to a stream engine 90 which is itself connected to a database of articles 110. It will be appreciated that this arrangement may be provided simultaneously with the arrangement of FIG. 4a. This arrangement allows for the updating of a user curated stream as described in more detail below. As illustrated in FIG. 4b, a user can access a story (or article) from a database of articles 110 via the web server. The system detects this access and queries with the user whether or not the story is to be added to the user curated stream and updates the stream as described below.

Referring now to FIG. 5a, a user curated stream is stored in the user curated stream database with its tag (step S100). Optionally, the addition of each new stream to the database may be published to the moderation tool. At step S102, the user curated stream with the tag “tag a” is obtained by the moderation tool from the database. The moderation tool determines whether or not to include the accessed stream with the tag “tag a” in the stream store at step S104. The moderation tool may determine whether or not to include the tagged stream by considering some or all of the following illustrative criteria:
a) The level of uniqueness of the new tag.
b) The country of origin for the new tagged stream.
c) The nature of the elements within the new tagged stream.
d) The level of redundancy of the words.

If the accessed tagged stream is not to be included, the system loops back to consider whether or not another curated stream is to be added to the database. If a tagged stream is accepted, the database known as the stream store is updated to include the new tagged stream Step S105. The database includes the stream with all its sources, the associated tag and also information identifying at least one user associated with the stream. This information identifying the user is useful as set out below.

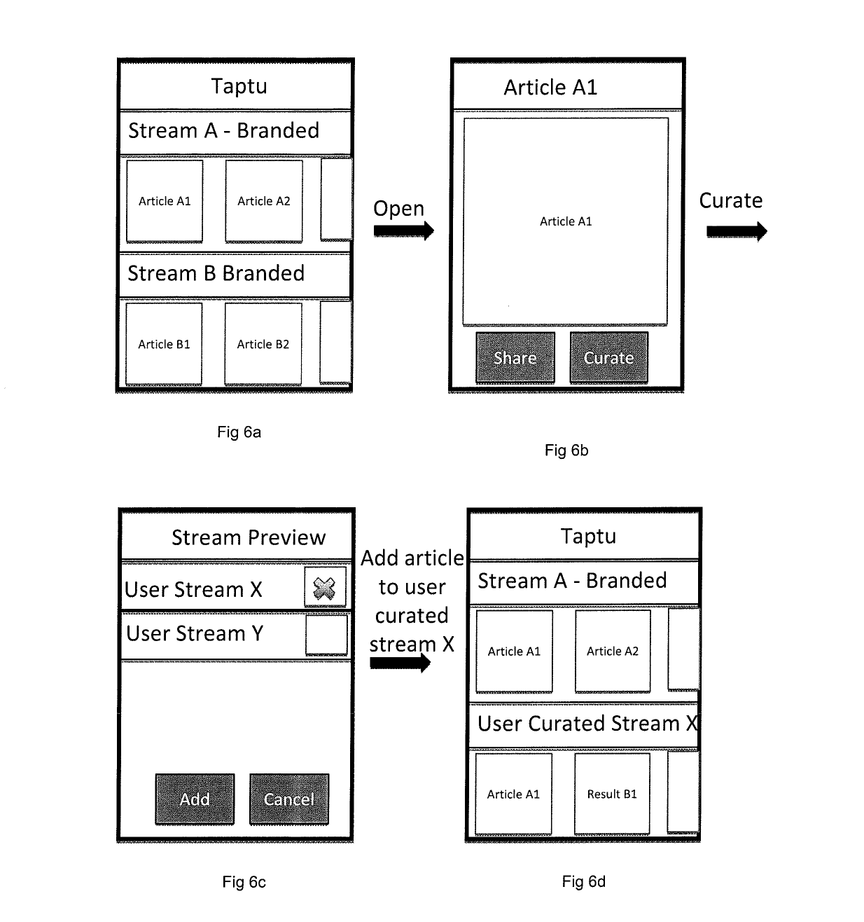

As shown in steps S106 to S110 and as illustrated in the screen shots of FIGS. 6a to 6d, the system is able to update each user curated stream in the stream store. In FIG. 6a, user A is browsing through two streams, stream A and stream B. User A selects article A1 from stream A which is opened in the user interface in FIG. 6b. At step S106 of FIG. 5a, the system determines that user A is reading and/or sharing at least one new story. At step S108 of FIG. 5a, the system displays an interface as shown in FIG. 6c to user A to suggest that the new story should be included in the user curated streams belongin to user A, namely User stream X and User Stream Y. The system then determines whether or not the user accepts the suggestion, for example by user A selecting “add”. If the suggestion is not accepted, the system loops back through the steps S106 to S110 again. If the suggestion is accepted, the system updates the appropriate user curated stream with the new story(ies) and displays this in the user interface shown in FIG. 6d.

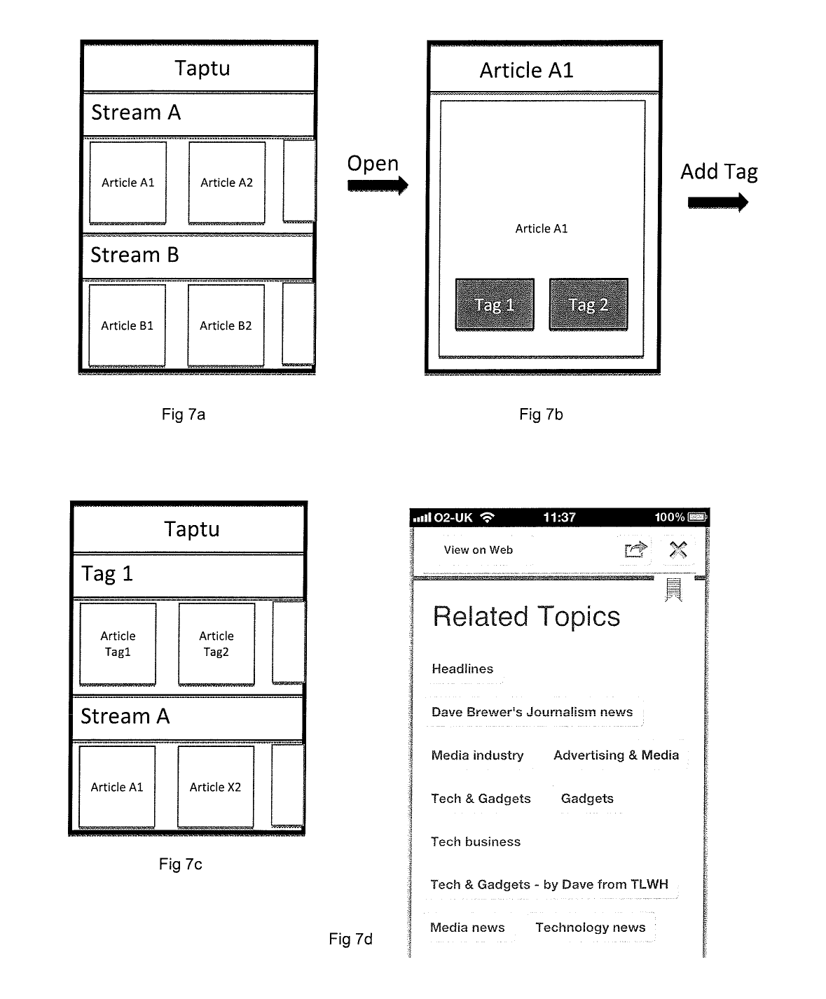

The effect of this update is illustrated in steps S112 to S114 which show the impact on a user B who is accessing the user curated stream tagged “tag a”. User B accesses the stream store via the query server. A user interface similar to that of FIG. 6a or FIG. 7a may be displayed. FIGS. 6a and 7a are screen shots showing how the user curated streams may be displayed on a user interface to user B. In this example User B is looking at the streams entitled “stream A”; and a stream entitled “stream B”. The display shows an image of each source or story within the stream. There is also an indication of the ages of each story in the stream.

User B scrolls through the displayed streams and selects a user curated stream of interest, e.g. the stream tagged “Stream A” (step S112). User B may thus be subscribed to the user curated stream “stream A” and when a new story is published on one or more of the sources covered in the stream, user B is notified. If the system updates the stream to include additional stories and/or sources as described in steps S106 to S100, at step S114, user B can access these additional stories too. The new stories may become available following a refresh of the stream by user B or may be positively pushed across to the stream by the system.

As shown in FIG. 4a, user A is marked as a curator and user B is marked as an optional curator. Thus as an alternative to a single user, multiple users may curate a stream. This process is shown in FIG. 5b. Steps S100 to S104 are the same as FIG. 5a. After the tagged stream has been accepted to the stream store, user A invites user B to be a co-curator of the tagged stream (step S306). It will be appreciated that the invite may be sent out before the tagged stream is accepted to the stream store. However, the following steps will only apply for an authorized tagged stream. User B may accept or decline the invite and the system determines which occurs at step S308. If the invite is declined, the user curated stream will be updated and used as described in FIG. 5a. However, if the invite is accepted the updating is modified as described below. It will be appreciated that multiple users can be invited to contribute to the user curated stream as joint curators and that two users are depicted for illustrative purposes only.

As shown in steps S310 to S314, updates to the user curated stream may be generated by activity from one or all users, e.g. one or both of user A and user B. Thus, at step S310, if the system determines that user A or user B or both are reading and/or sharing a new story, a user interface is displayed to the appropriate user(s) at step S312. The interface suggests including the new story in the stream. The system determines whether or not any new stories are added at step S314.

The impact of any updating is shown on user C who has subscribed to the stream jointly curated by user A and user B (step S316). Any updates are added at step S318 in a similar manner to that described in relation to FIG. 5a.

The jointly curated stream may be used in a similar manner to the single user curated stream. Thus as described above; the system may provide a notification to a user that the jointly curated stream is available.

It will be appreciated that the tags themselves may be used by the system to improve functionality. One use is to provide an alternative to a user accessing the stream via a search through the stream store; the system may provide a notification to a user that the stream is available. For example, as shown in FIGS. 7a to 7d, user C accesses the stream store via the query server. A user interface shown FIG. 7a is displayed showing a plurality of streams. The streams may be user curated streams or other mixed streams. User C selects a story “Article A1” which forms part of the stream A. As shown in FIG. 7b; the system notifies user C that this story is associated with two tags “tag 1” and “tag 2”. This is achieved by displaying the names of the tag alongside the story. In this way, user C is provided with some context for the story and can use the tagged stream to find other content of interest. For example, if User C selects the button marked “tag 1” this has an automatic link to take user C to the rest of the stream which is displayed in a user interface similar to that of FIG. 7a.

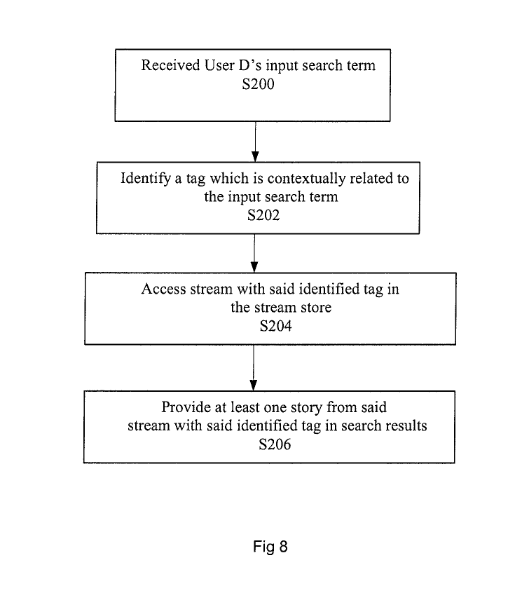

The tags and their associated streams may be used to improve searching as illustrated in the flowchart of FIG. 8.

At step S200, user D inputs a search to the system using a keyword. At step S202, the system determines that the keyword used is contextually related to one of the tags for a stream. At step S204, the system accesses the stream store to determine the stories which form part of the “golf news” stream and returns at least one of these stories as part of the search results. The system may include some or all of the stories or sources forming part of the stream as the search result. Additionally, the system may conduct a search in the standard manner to return results, e.g. from the query server using a web crawler (not shown) to crawl the Internet.

The system may be configured to automatically determine any contextually related tags, e.g. the key word “putter” is input and the system recognizes that this is contextually related to the tag “golf news”. Alternatively, user D may have selected a tag from the stream store to add to the input search term and the system identifies that it has been included at step S202.

In all of the above embodiments, the search may be conducted on a mobile device which may be any kind of mobile computing device, including laptop and hand held computers, portable music players, portable multimedia players, mobile phones. Users can use mobile devices such as phone-like handsets communicating over a wireless network, or any kind of wirelessly-connected mobile devices including PDAs, notepads, point-of-sale terminals, laptops etc. Each device typically comprises one or more CPUs, memory, I/O devices such as keypad, keyboard, microphone, touch screen, a display and a wireless network radio interface.

These devices can typically run web browsers or microbrowser applications e.g. Openwave™, Access™, Opera™ Mozilla™ browsers, which can access web pages across the Internet. These may be normal HTML web pages, or they may be pages formatted specifically for mobile devices using various subsets and variants of HTML, including cHTML, WML, DHTML, XHTML, XHTML Basic and XHTML Mobile Profile. The browsers allow the users to click on hyperlinks within web pages which contain URLs (uniform resource locators) which direct the browser to retrieve a new web page.

The Web server can be a PC type computer or other conventional type capable of running any HTTP (Hyper-Text-Transfer-Protocol) compatible server software as is widely available. The Web server has a connection to the Internet 30. These systems can be implemented on a wide variety of hardware and software platforms.

The query server, moderation tool server and servers for indexing, calculating metrics and for crawling or metacrawling can be implemented using standard hardware. The hardware components of any server typically include: a central processing unit (CPU), an Input/Output (I/O) Controller, a system power and clock source; display driver; RAM; ROM; and a hard disk drive. A network interface provides connection to a computer network such as Ethernet, TCP/IP or other popular protocol network interfaces. The functionality may be embodied in software residing in computer-readable media (such as the hard drive, RAM, or ROM). A typical software hierarchy for the system can include a BIOS (Basic Input Output System) which is a set of low level computer hardware instructions, usually stored in ROM, for communications between an operating system, device driver(s) and hardware. Device drivers are hardware specific code used to communicate between the operating system and hardware peripherals. Applications are software applications written typically in C/C++, Java, assembler or equivalent which implement the desired functionality, running on top of and thus dependent on the operating system for interaction with other software code and hardware. The operating system loads after BIOS initializes, and controls and runs the hardware. Examples of operating systems include Linux™, Solaris™, Unix™, OSX™ Windows XP™ and equivalents.

The query server may provide for user login. The user is identified by registering a username and password and then subsequently by logging in with the same username and password. The registration process is a one-time process per user. In a preferred embodiment, the login process is also a one-time process per user by caching their credentials (or a unique key representing their identity) in a cookie. However, where cookies are not supported then the user is required to provide username and password per result publication. The user could be required to login at the first page of the mobile search service, however, in the preferred embodiment, the user is only prompted for login (if not already identified) when first attempting to connect.

No doubt many other effective alternatives will occur to the skilled person. It will be understood that the invention is not limited to the described embodiments and encompasses modifications apparent to those skilled in the art lying within the spirit and scope of the claims appended hereto.

We claim:

1. A system comprising a database and a processor for updating said database, the processor being configured to:
receive a first user stream comprising a set of elements of online content together with an associated tag;
determine whether or not said associated tag is to be added to the database by considering whether said associated tag meets predefined criteria; and
update said database if said predefined criteria are met;
wherein said updating step includes storing said associated tag in said database.

2. A system according to claim 1, wherein said predefined criteria include a level of uniqueness of said tag.

3. A system according to claim 2, wherein when said tag is similar to existing tags, said predefined criteria includes a consideration of the elements contained in said first user stream.

4. A system according to claim 2, wherein when said tag is similar to existing tags, said predefined criteria includes determining a country of origin of said first user stream.

5. A system according to claim 1, wherein said first user stream comprises a search stream listing a plurality of search results.

6. Apparatus according to claim 5 wherein said updating step includes tagging each search result in said search stream with said stored tag.

7. A system according to claim 1, wherein said system further comprises a user interface to allow said first user to define which elements are to be included in said first user stream and to define the associated tag.

8. A system according to claim 7, wherein said user interface comprises a element input for a user to add elements to said first user stream and a tag input for a user to add said tag to said first user stream.

9. A system according to claim 1, wherein said database is further configured to store said streams of online content and wherein said updating step includes storing said elements from said first user stream in said database together with said associated tag.

10. A system according to claim 9, and wherein said updating step further includes storing information identifying said first user.

11. A system according to claim 10, wherein said processor is further configured to update said database by:
detecting that said first user is accessing at least one additional element which is not included in said elements from said first user stream stored within said database;
displaying a user interface to said first user, said user interface comprising a user input to add said at least one additional element to said first user stream;
determining whether or not said user adds said at least one additional element to said first user stream; and
updating said database based on said determining step.

12. A system according to claim 9, wherein said processor is further configured to update said database by
determining that a second user is associated with said first user stream;
detecting that at least one of said first user and said second user is accessing at least one additional element which is not included in said first user stream stored within said database;
displaying a user interface to said at least one user accessing said at least one additional element, said user interface comprising a user input to add said at least one additional element to said first user stream;
determining whether or not said at least one user adds said at least one additional element to said first user stream; and
updating said database based on said determining step.

13. A system according to claim 12, wherein said processor determines that said second user is associated with said first user stream by:
displaying a user interface to said second user, said user interface displaying at least a portion of said first user stream and an invitation to said second user to be associated with said first stream, said user interface comprising a user input to indicate that said invitation is accepted; and
determining whether or not said second user accepts said invitation.

14. A system according to claim 11, further comprising a display for displaying said first user stream to another user wherein said display is updated when said database is updated.

15. A computer-implemented method of updating a database of streams of online content, the method comprising
receiving a first user stream comprising a set of elements of online content together with an associated tag;
determining whether or not said associated tag is to be added to the database by considering whether said associated tag meets predefined criteria; and
updating said database if said predefined criteria are met;
wherein said updating step includes storing said associated tag in said database.

16. A non-transitory carrier carrying processor control code which when running on a computer causes the computer to carry out the method of claim 11.

17. A system comprising a database of streams of online content and a processor for updating said database, the processor being arranged to
receive a first user stream comprising a set of elements of online content together with an associated tag;
determine whether or not said first user stream is to be added to the database by considering whether said associated tag meets predefined criteria; and
update said database if said predefined criteria are met;
wherein said updating step includes storing said first user stream in said database together with said associated tag and information identifying said first user.

18. Apparatus for providing a search service for finding online content, the apparatus being arranged to
receive a search query from a user;
access a database comprising a plurality of elements of online content, each element having an associated tag;
identify a tag which is contextually relevant to the search query;
select at least one element associated with said identified tag to include in a set of search results to said user, and
send search results to said user.

19. Apparatus according to claim 18 arranged to send said at least one selected element together with said tag of said search results.

20. Apparatus according to claim 18 further arranged to
identify a plurality of tags which are contextually relevant to the search query;
access each of said plurality of predefined set of elements of online content associated with said plurality of identified tags; and
select at least one element from each of said identified predefined set of elements to include in a set of search results to said user.

21. Apparatus according to claim 18 arranged to determine that said tag is contextually relevant to the search query, when all or part of said tag is identical to all or part of said search query.

22. Apparatus according to claim 18 wherein said receive search query includes a tag and said apparatus is arranged to identify said tag within said search query.
